(19) United States
(12) Patent Application Publication
(10) Pub. No.: US 2009/0131128 A1
(43) Pub. Date: May 21, 2009

(54) PORTABLE COMMUNICATION DEVICE

(75) Inventor: Young S. KIM, Los Altos, CA (US)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/263,707

(22) Filed: Nov. 3, 2008

(30) Foreign Application Priority Data
Nov. 2, 2007 (KR) 10-2007-0111504

(51) Int. Cl. H04M 1/00

(52) U.S. Cl. 455/575.4

(57) ABSTRACT

A portable communication device includes a main body housing having a mounting groove on a first surface thereof, and a sliding/pivoting housing slidably mounted in the mounting groove and rotatable about a hinge axis in one side thereof. Alternatively, a portable communication device may include a main body housing having a mounting groove on a first surface thereof and a hinge axis in a first side thereof, and a sliding/pivoting housing to rotate about the hinge axis, such that the sliding/pivoting housing rotates about the hinge axis when a first side thereof is positioned on the hinge axis.

### CROSS REFERENCE TO RELATED APPLICATION

This application claims priority from and the benefit of Korean Patent Application No. 10-2007-0111504, filed on Nov. 2, 2007, which is hereby incorporated by reference for all purposes as if fully set forth herein.

### BACKGROUND OF THE INVENTION

1. Field of the Invention

The present invention relates to a portable communication device, and more particularly to a portable communication device including various types of input units.

2. Discussion of the Background

Generally, a portable communication device is a portable device through which a user may perform radio communication with others. The user may enjoy various kinds of services, such as a voice call, short message transmission/reception, a multimedia service, and entertainment, while carrying the portable communication device. Such a portable communication device may be classified as a bar-type, a flip-type, or a folder-type communication device according to its external shape. The bar-type communication device is a device in which data input/output unit and a transmitter/receiver are provided in a single body housing. The bar-type communication device, however, may malfunction because a keypad, i.e. a data input unit, is continuously exposed to the outside, and miniaturization thereof may be difficult because the transmitter and the receiver should secure a certain distance therebetween. The flip-type communication device includes a main body, a flip, and a hinge module to connect the main body and the flip. The data input/output unit and the transmitter/receiver are provided in the main body, and the flip covers the key pad of the data input unit to prevent malfunction thereof. However, the flip-type communication device may be difficult to miniaturize because of a distance between the transmitter and the receiver should be secured. The folder-type communication device includes a main body, a folder, and a hinge module to rotatably connect the main body and the folder, so that the main body may be opened/closed as the folder is pivoted. In a stand-by mode, the folder is brought into contact with the main body to prevent malfunction of the key pad, and in a calling mode, the folder is pivoted to secure a distance between the transmitter and the receiver. Thus, the folder-type communication device may be more easily miniaturized. Further, a slidable-type communication device has been recently proposed, in which first and second housings are slidably coupled to each other, so that the first housing slides over the second housing when the housings overlap to open a portion of the second housing. A key pad unit of such a portable communication device is an input unit that may be manipulated by a user to allow a corresponding value to be displayed on a display or allow the communication device to operate. The key pad unit has a 3×4 key arrangement of input keys for call-connection and call-disconnection. Furthermore, recent developments have been made to the portable communication device so as to provide a multimedia service, such as a video call, a moving picture, and music reproduction, as well as a wireless internet service. Thus, the key pad unit of such a portable communication device may include function keys to allow a user to call diverse menus, functions and the like, and a QWERTY key arrangement to allow a user to use a wireless internet service more quickly and more conveniently. Thus, the number of keys that are mounted on the portable communication device to use diverse functions may increase. Herein, the size of an area where the key pad is mounted may increase, which may make it difficult to miniaturize and lighten the portable communication device. Although the keys may be made to be smaller so that more keys may be mounted in a restricted area, this may cause inconvenience in the operation of the keys. Further, in the portable communication device, only a portion of the keys may be manipulated according to the operation mode of the portable communication device. Here, if other keys, which do not correspond to the operation mode of the portable communication device, are manipulated by error, a malfunction of the portable communication device may occur.

### SUMMARY OF THE INVENTION

The present invention provides a portable communication device in which only a portion of keys, which correspond to a current operation mode of the portable communication device, are exposed.

The present invention also provides a portable communication device in which keys are mounted so to be conveniently manipulatable while being used in diverse functions.

The present invention also provides a portable communication device that may prevent unnecessary exposure of keys, thereby preventing malfunction.

The present invention also provides a portable communication device that may be easily miniaturized and lightened while having an enlarged input unit, such as a key pad.

Additional features of the invention will be set forth in the description which follows, and in part will be apparent from the description, or may be learned by practice of the invention.

The present invention discloses a portable communication device including a main body housing having a mounting groove on a first surface thereof and a sliding/pivoting housing slidably mounted in the mounting groove to be rotatable about a hinge axis in a first side of the sliding/pivoting housing.

The present invention also discloses a portable communication device including a main body housing having a mounting groove on a first surface thereof and a hinge axis in a first side thereof and a sliding/pivoting housing to rotate about the hinge axis. The sliding/pivoting housing rotates about the hinge axis when a first side of the sliding/pivoting housing is positioned on the hinge axis.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a portable communication device according to a first exemplary embodiment of the present invention.

FIG. 2 is a perspective view showing a state in which the first side of a sliding/pivoting housing of the portable communication device shown in FIG. 1 is moved from a first position to a second position.

FIG. 3 is a perspective view showing the state in which a first side of the sliding/pivoting housing of the portable communication device shown in FIG. 1 is positioned at the second position.

FIG. 4 is a perspective view showing the state in which the sliding/pivoting housing of the portable communication device shown in FIG. 1 rotates about a hinge axis.

FIG. 5 is a perspective view showing the state in which the sliding/pivoting housing of the portable communication device shown in FIG. 1 overlaps with a main body housing while rotating.

FIG. 6 is a perspective view showing the state in which the main body housing and the sliding/pivoting housing of the portable communication device shown in FIG. 1 are separated from each other.

FIG. 7 is a cross-sectional view taken along lines B-B′ and C-C′ in the portable communication device shown in FIG. 1.

FIG. 8 is a cross-sectional view showing the state in which the sliding/pivoting housing of the portable communication device shown in FIG. 7 slides.

FIG. 9 is a cross-sectional view showing the state in which the sliding/pivoting housing of the portable communication device shown in FIG. 8 rotates about a hinge axis.

FIG. 10 is a perspective view showing the hinge member 110 of the portable communication device 100 shown in FIG. 6.

FIG. 11 is a perspective view showing the state in which a main body housing and a sliding/pivoting housing of a portable communication device according to a second exemplary embodiment of the present invention are separated from each other.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

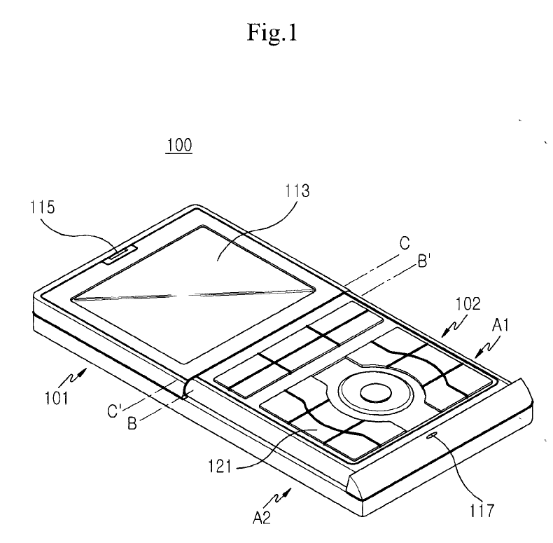

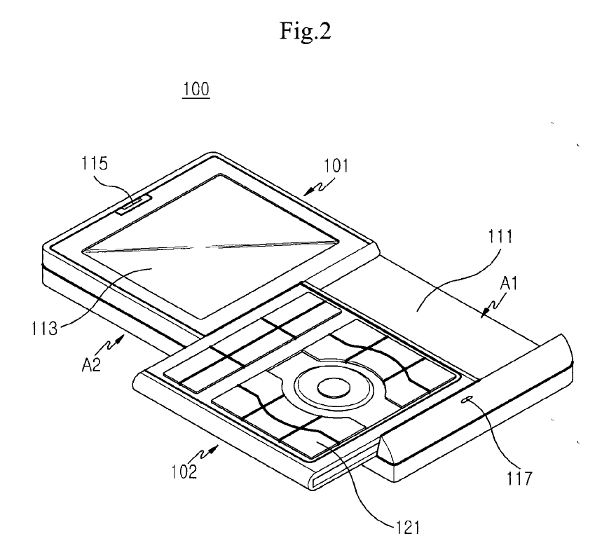

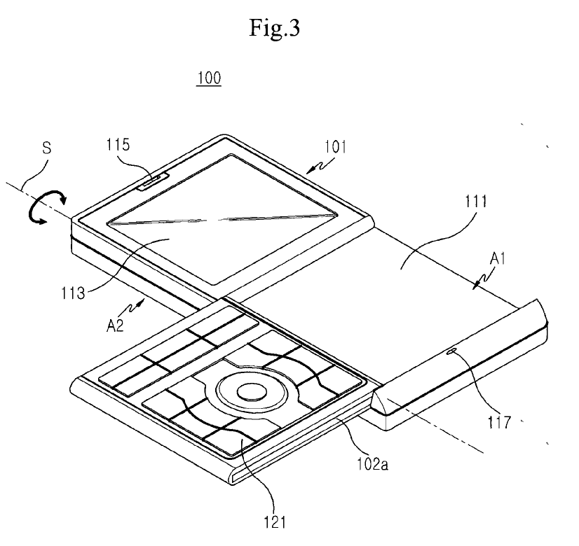

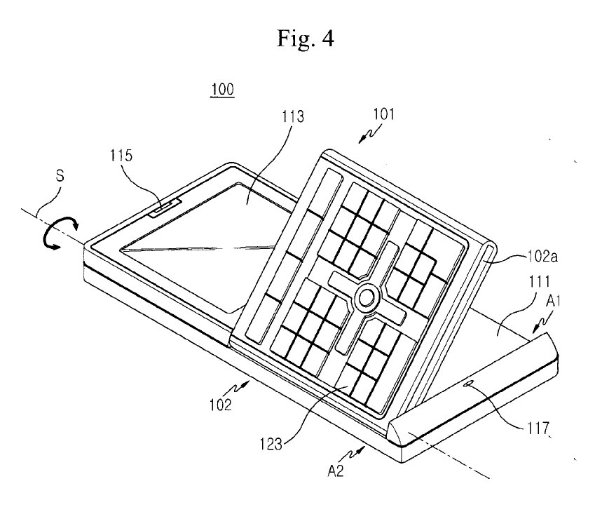

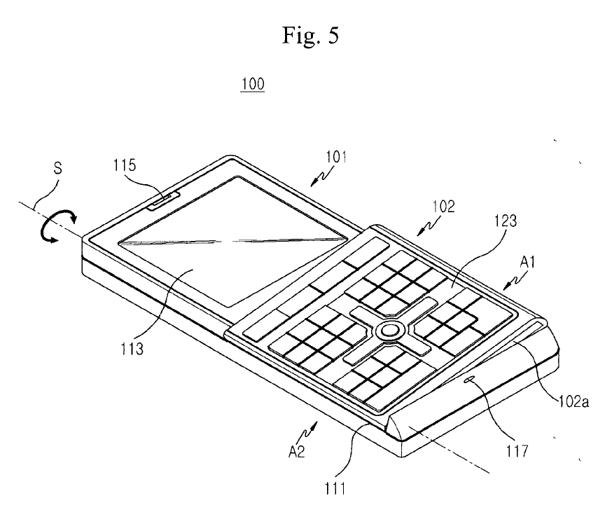

FIG. 1 is a perspective view showing a portable communication device 100 according to a first exemplary embodiment of the present invention, FIG. 2 is a perspective view showing the state in which a first side of a sliding/pivoting housing 102 of the portable communication device 100 shown in FIG. 1 is moved from a first position A1 toward a second position A2, FIG. 3 is a perspective view showing the state in which the first side of the sliding/pivoting housing 102 of the portable communication device 100 shown in FIG. 1 is positioned at the second position A2, FIG. 4 is a perspective view showing the state in which the sliding/pivoting housing 102 of the portable communication device 100 shown in FIG. 1 rotates about a hinge axis S, and FIG. 5 is a perspective view showing the state in which the sliding/pivoting housing 102 of the portable communication device 100 shown in FIG. 1 overlaps with a main body housing 101 while rotating. As shown in FIG. 1, FIG. 2, FIG. 3, FIG. 4, and FIG. 5, the portable communication device 100 according to the first exemplary embodiment includes the main body housing 101 and the sliding/pivoting housing 102. The main body housing 101 includes a mounting groove 111, a display 113, a receiver 115, and a transmitter 117 on a first surface thereof, and serves to implement a voice call and provide a user with an image display. The main body housing 101 has a hinge axis S in one side thereof. The mounting groove 111 is recessed in a lower portion of the first surface of the main body housing 101. Opposite sides of the mounting groove are open. The display 113 is mounted on an upper portion of the first surface of the main body housing 101 so as to be adjacent to the mounting groove 111. The display may include an element such as a liquid crystal display (LCD), a thin film transistor (TFT), or the like. The display 113 may display the status information of a communication device, such as transmitting/receiving sensitivity to a base station, a residual power quantity of a battery, or the like, data transmission/reception information, and a received short message, and also may output a moving picture or a broadcasting image according to an operation mode of the portable communication device 100. The receiver 115 is installed above the display 113 and includes a speaker therein. The receiver 115 may output voice received by the portable communication device 100, sounds of reproduced music or moving pictures, and sounds of a broadcasting service. The transmitter 117 is mounted in the lower side of the mounting groove 111 and includes a microphone therein. A user's voice is input to the transmitter 117 to be transmitted to a call-recipient. Further, with the combination between the transmitter 117 and the receiver 115, the portable communication device 100 provides a function of a voice call between a caller and a call-recipient. The sliding/pivoting housing 102 is mounted in the mounting groove 111 such that it slides to protrude from a first side of the main body housing 101. When the sliding/pivoting housing reaches an end point, it can rotate within a range of 180° about the hinge axis S. In the present exemplary embodiment, when the sliding/pivoting housing 102 overlaps with the main body housing 101, it is slidable in one side direction of the main body housing 101. That is, a first side of the sliding/pivoting housing 102 may slide from the second side to the first side of the main body housing 101. Further, when the sliding/pivoting housing 102 slides so that the first side thereof travels from the second side of the main body housing 101 to the first side of the main body housing 101, the movement of the sliding/pivoting housing 102 is restricted at two points, which are referred to as first and second positions A1 and A2.

When the sliding/pivoting housing 102 overlaps with the main body housing 101, a first side thereof is positioned at the first position A1, and a first surface thereof, i.e. an upper surface thereof, is exposed to the outside. Then, as the sliding/pivoting housing 102 slides to protrude from the first side of the main body housing 101, the first side thereof reaches the second position A2. When the first side of the sliding/pivoting housing 102 is positioned at the second position A2, the sliding/pivoting housing 102 may rotate 180° about the hinge axis S, so that it overlaps with the main body housing 101, and a second surface thereof, i.e. the back surface thereof, is exposed to the outside. The sliding/pivoting housing 102 is provided with a plurality of keys on each of the first and second surfaces thereof, i.e. the upper and back surfaces thereof, and corresponding signs are respectively printed on the keys. Further, when the keys of the sliding/pivoting housing 102 are manipulated by a user, corresponding values of the keys may be displayed on the display 113 or the portable communication device 100 may be operated. Because the keys of the sliding/pivoting housing 102 are apportioned between the upper and back surfaces, and the sliding/pivoting housing rotates about the hinge axis S, the upper and back surfaces thereof may be selectively exposed to the outside. Thus, a user may manipulate a required key using a diversified key arrangement according to the current operation mode. Further, the exposed surfaces of the sliding/pivoting housing 102 may be flush with the display 113. Here, the keys arranged on the first surface, e.g. the upper surface, of the sliding/pivoting housing 102 are referred to as a first key pad 121, and the keys on the second surface, e.g. the back surface, of the sliding/pivoting housing 102 are referred to as a second key pad 123.

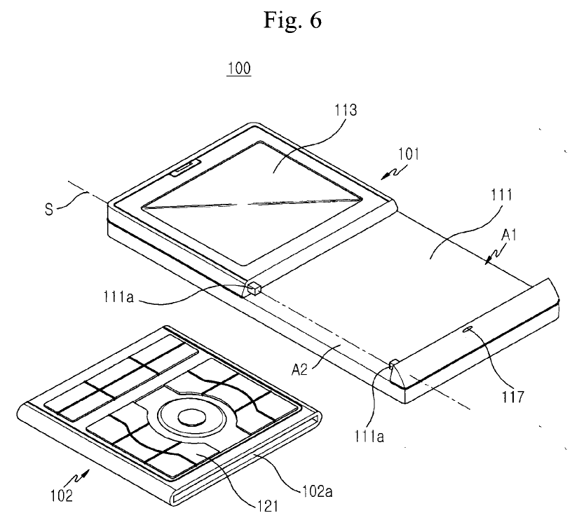

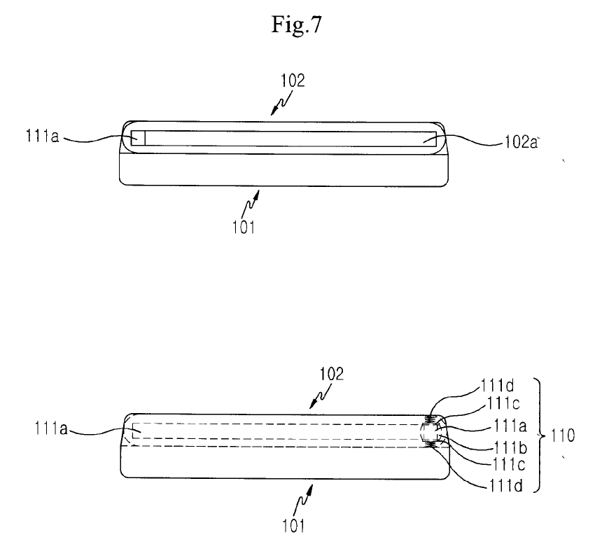

The first key pad 121 may have a 3×4 key arrangement and may correspond to a service of the portable communication device 100, such as a voice call or a short message transmission. In particular, the first key pad 121 may be composed of number keys, so that a user may input a phone number of a call-recipient to make a call or send a message to the call-recipient. The first key pad 121 may further include keys to execute and terminate a service or activate a menu in addition to the 3×4 key arrangement. The second key pad 123 may have a QWERTY key arrangement and may correspond to a wireless internet service of the portable communication device 100. In particular, the second key pad 123 may have a key arrangement such as that of a personal computer, so that a user can write out mail in long sentences or use a wireless internet service using the second key pad 123. Meanwhile, the first and second key pads 121 and 123 are respectively provided with direction keys to make a video call or seek file information required for enjoyment of music or moving picture. Further, the main body housing 101 and the sliding/pivoting housing 102 are coupled to each other by a hinge member 110 (See FIG. 7) and guide grooves 102a (See FIG. 6), which are respectively provided in the main body housing 101 and the sliding/pivoting housing 102.

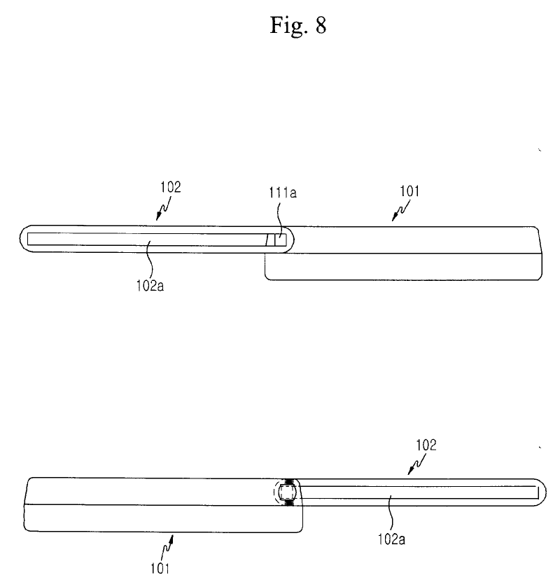

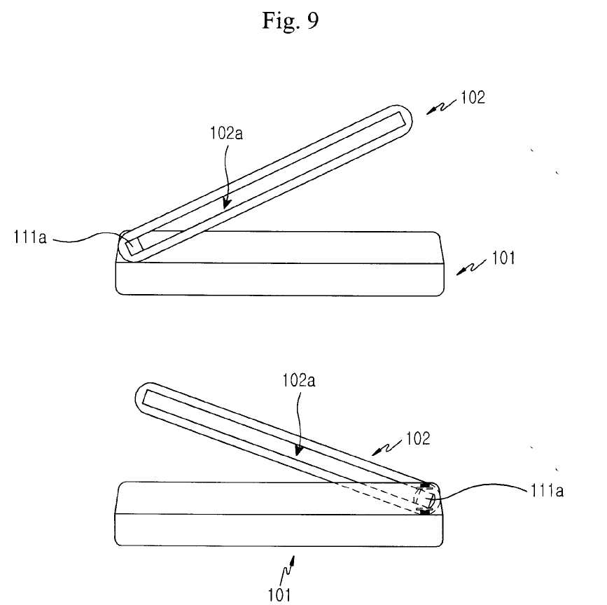

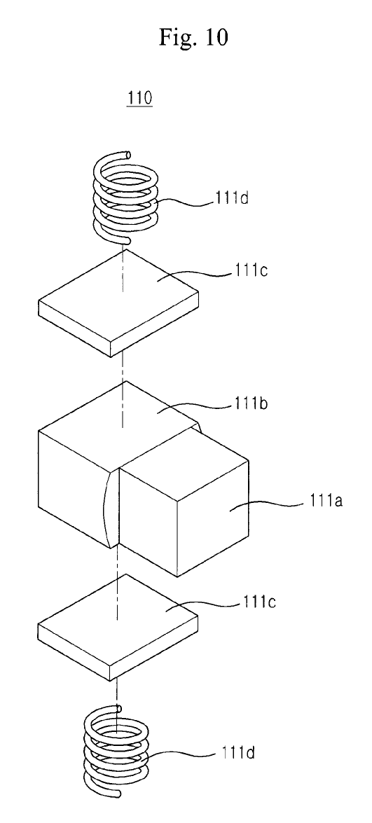

FIG. 6 is a perspective view showing the main body housing 101 and the sliding/pivoting housing 102 of the portable communication device 100 shown in FIG. 1, FIG. 7 is a cross-sectional view taken along lines B-B′ and C-C′ in the portable communication device 100 shown in FIG. 1, FIG. 8 is a cross-sectional view showing a state in which the sliding/pivoting housing 102 of the portable communication device 100 shown in FIG. 7 is slid, FIG. 9 is a cross-sectional view showing the state in which the sliding/pivoting housing 102 of the portable communication device 100 shown in FIG. 8 rotates about the hinge axis S, and FIG. 10 is a perspective view showing the hinge member 110 of the portable communication device 100 shown in FIG. 6. As shown in FIG. 6, FIG. 7, FIG. 8, FIG. 9, and FIG. 10, as the sliding/pivoting housing 102 slides or rotates while being mounted in the mounting groove 111, the hinge member 110 operates while engaged with the guide grooves 102a. The hinge member 110 is installed on the hinge axis S with a portion thereof protruding from an inner wall of the mounting groove 111, and includes first and second hinge projections 111a and 111b, a hinge support piece 111, and a hinge spring 111d.

The first hinge projection 111a has an outer flat circumferential face, and extends toward a direction of the hinge axis S to protrude from the inner wall of the mounting groove 111. The second hinge projection 111b extends from the first hinge projection 111a and is received in the main body housing 101. The second hinge projection 111b has an outer circumferential face, a portion of which has a flat shape. In particular, the outer circumferential face of the second hinge projection 111b has a flat face and a curved face that are alternatively arranged in a circumferential direction. The hinge support piece 111c has flat shape, and is brought into close contact with the outer circumferential face of the second hinge projection 111b while being received in the main body housing 101. Further, since the hinge support piece 111c has the flat shape, it may be stably brought into close contact with the flat face of the second hinge projection 111b. The hinge spring 111d provides an elastic force to force the hinge support piece 111c against the outer circumferential face of the second hinge projection 111b with opposite ends thereof supported between an inside of the main body housing 101 and the hinge support piece 111c. The elastic force of the hinge spring 111d allows the hinge support piece 111c to be brought into close contact with the outer circumferential face of the second hinge projection 111b, so that the hinge support piece may be stably held on the second hinge projection. A guide groove 102a is recessed in each of the upper and lower sides of the sliding/pivoting housing 102 in a longitudinal direction thereof. A portion of the hinge member 110, in particular, the first hinge projection 111a, is inserted into the guide groove 102a. Here, the first hinge projection 111a has an outer flat circumferential face, and is positioned inside the guide groove 102a while facing upper and lower inner walls of the guide groove 102a. Further, the sliding/pivoting housing 102 slides in the mounting groove 111 while being guided by the first hinge projection 111a. Further, the outer circumferential face of the first hinge projection 111a is brought into contact with opposite sides of the guide groove 102a, so that a range of the sliding movement of the sliding/pivoting housing 102 may be restricted by the mounting groove 111.

The hinge support piece 111c receives the elastic force from the hinge spring 111d so as to be brought into close contact with the flat face of the second hinge projection 111b. Thus, the sliding/pivoting housing 102 is slidable between a position in which it overlaps with the main body housing 101 and a position in which the first side thereof is positioned at the second position.

When the sliding/pivoting housing 102 slides to protrude from the first side of the main body housing 101, it is rotatable about the hinge axis S. Here, since the outer flat circumferential face of the first hinge projection 111a interferes with the inner walls of the guide groove 102a when the sliding/pivoting housing rotates, the first and second hinge projections 111a and 111b also may rotate about the hinge axis S. As the sliding/pivoting housing 102 rotates about the hinge axis S, the second hinge projection 111b rotates while the curved face thereof slides on the hinge support piece 111c. Further, the hinge support piece 111c remains in contact with the second hinge projection 111b due to the elastic force of the hinge spring 111d.

When the sliding/pivoting housing 102 rotates and overlaps with the main body housing 101, the hinge support piece 111c is brought into close contact with the flat face of the second hinge projection 111b. Thus, the sliding/pivoting housing 102 continues to overlap with the main body housing 101. As a result, the sliding/pivoting housing 102 may rotate when the first side thereof is positioned at the second position A2, so that it may overlap the main body housing 101. When the sliding/pivoting housing 102 overlaps with the main body housing 101 with the first side thereof positioned at the second position A2, the second key pad 123 is exposed to the outside. In this state, the sliding/pivoting housing 102 may rotate to protrude from the first side of the main body housing 101, and then slide so that the first side thereof is positioned at the first position A1 and the sliding/pivoting housing overlaps with the main body housing 101. This process may alternatively be implemented by an inverse process in which the sliding/pivoting housing 102 slides, rotates, and then overlaps the main body housing 101. For example, when the second side of sliding/pivoting housing 102 is positioned at the first position A1 and the sliding/pivoting housing 102 overlaps with the main body housing 101, the sliding/pivoting housing 102 may slide so that the second side thereof is positioned at the second position A2 and the sliding/pivoting housing 102 protrudes from the main body housing 101. The sliding/pivoting housing 102 may then rotate so that the first side thereof is at the first position A1 and the sliding/pivoting housing 102 overlaps with the main body housing 101 with the first surface of the sliding/pivoting housing 102 exposed.

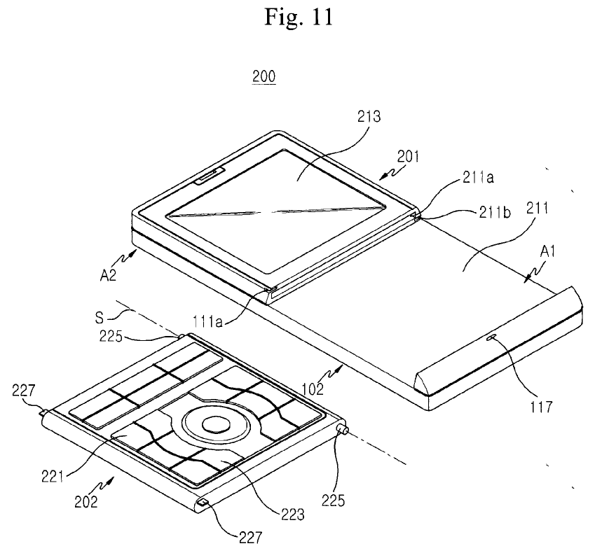

FIG. 11 is a perspective view showing the state in which a main body housing 201 and a sliding/pivoting housing 202 of a portable communication device 200 according to a second exemplary embodiment of the present invention are separated from each other. As shown in FIG. 11, the portable communication device 200, as in that of the first exemplary embodiment, includes a main body housing 201 and a sliding/pivoting housing 202, which may be mounted in a mounting groove 211 of the main body housing 201 so as to slide toward one side of the main body housing 201. The present exemplary embodiment is different from the first exemplary embodiment in that the sliding/pivoting housing 202 has a hinge axis S in one side thereof, so that as the sliding/pivoting housing 202 slides, the hinge axis S slides in the mounting groove 211. Thus, unlike the first exemplary embodiment, the sliding/pivoting housing 202 may rotate while sliding on the main body housing 201, and after rotating, it may continue to overlap with the main body housing 201 via the sliding movement. In the present exemplary embodiment, the sliding/pivoting housing 202 is mounted in the mounting groove 211 of the main body housing 201 such that a hinge projection 225 thereof is fitted into a guide groove 211a of the main body housing 201. The guide groove 211a is recessed in an inner wall of the mounting groove 211 in a longitudinal direction thereof. A hinge projection 225 protrudes from each of an upper side and a lower side of the sliding/pivoting housing 202, and the hinge projections 225 are mounted on the hinge axis S. When the hinge projections 225 are fitted into the guide grooves 211a, the sliding/pivoting housing 202 is mounted in the mounting groove 211. Here, the hinge projections 225 slide along the guide grooves 211a while being fitted into the guide grooves to guide the sliding movement of the sliding/pivoting housing 202, and also serve as the center of rotation of the sliding/pivoting housing 202. The main body housing 201 and the sliding/pivoting housing 202 are respectively provided with a fixing groove 211b and a fixing projection 227 to maintain an overlapping state therebetween. The fixing grooves 211b are provided in the inner walls of the mounting groove 211 adjacent to the guide grooves 211a. The fixing projections 227 protrude from upper and lower sides of the sliding/pivoting housing 202 at the first side thereof, and have a shape to be inserted into the fixing grooves 211b. As the sliding/pivoting housing 202 slides, the fixing projections 227 are selectively engaged with the fixing grooves 211b. In particular, when the sliding/pivoting housing 202 overlaps with the main body housing 201, the fixing projections 227 are inserted into the fixing grooves 221b. When the fixing projections 227 and the fixing grooves 211b are engaged with each other, the sliding/pivoting housing 202 is prevented from rotating while maintaining the overlapping state with the main body housing 201.

When the sliding/pivoting housing 202 overlaps with the main body housing 201, the hinge axis S is positioned at a first position A1, and the upper surface of the sliding/pivoting housing 202, in particular a first key pad 221, is exposed to the outside. Here, the fixing projections 227 are inserted into the fixing grooves 211b provided in the inner walls of the mounting groove 211 to restrict the rotation of the sliding/pivoting housing 202. Further, as the sliding/pivoting housing 202 slides toward first side of the main body housing 201, the hinge axis S slides toward a second position A2. When the sliding/pivoting housing 202 slides from a state in which it overlaps with the main body housing 201, to a state in which it protrudes from the first side of the main body housing 201, the fixing projections 227 are disconnected from the fixing grooves 211b provided in the inner walls of the mounting groove 211. Thus, the sliding/pivoting housing 202 may rotate within a range of 180° about the hinge axis S. That is, while the hinge axis S is moved from the first position A1, the sliding/pivoting housing 202 may rotating 180° about the hinge axis S such that the back surface thereof is exposed to the outside. Further, the fixing projections 227 are positioned adjacent to the fixing grooves 211b provided in the other sides of the inner walls of the mounting groove 211. The sliding/pivoting housing 202 slides toward the first side of the main body housing 201 to allow the fixing projections 227 to be engaged with the fixing grooves 211b, and overlaps the main body housing 201. Here, the hinge axis S is positioned at the second position A2, and the other surface of the sliding/pivoting housing 202, in particular, a second key pad 223, is exposed to the outside.

A process in which the sliding/pivoting housing 202 moves to overlap with the main body housing 201 from a state in which the lower surface, which includes the second key pad 223 thereof is exposed may be implemented by an inverse process of the above process. Thus, the process in which the sliding/pivoting housing 202 moves to overlap with the main body housing 201 from a state in which the lower surface thereof is exposed will not be described.

According to exemplary embodiments of the present invention, the portable communication device includes the main body housing having the mounting groove, and the sliding/pivoting housing slidably mounted in the mounting groove and rotating about the hinge axis. The sliding/pivoting housing may be provided with different key arrangements on opposite surfaces, respectively. As the hinge projections provided in one of main body housing and the sliding/pivoting housing, and the guide grooves provided on the other housing are engaged with each other, the sliding/pivoting housing may rotate about the hinge axis while being slidably moved on the main body housing, so that it overlaps with the main body housing with opposite surfaces thereof selectively exposed to the outside. Thus, since only the required keys are selectively exposed according to the current operation mode of the portable communication device, a user may manipulate the portable communication device with convenience. Further, since keys that do not correspond to the current operation mode are not exposed, malfunction of the portable communication device may be prevented. Furthermore, since the keys are between opposite surfaces of the pivoting housing, the portable communication device may be made smaller and lighter.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable communication device, comprising:
a main body housing having a mounting groove on a first surface thereof; and
a sliding/pivoting housing slidably mounted in the mounting groove and pivotable about a hinge axis in a first side of the sliding/pivoting housing.

2. The portable communication device of claim 1, wherein the hinge axis is positioned at a first position when the sliding/pivoting housing overlaps with the main body housing, and is positioned at a second position when the sliding/pivoting housing protrudes from a first side of the main body housing after the sliding/pivoting housing slides from a position at which the sliding/pivoting housing overlaps with the main body housing, and
wherein the sliding/pivoting housing is rotatable about the hinge axis to overlap with the main body housing when the hinge axis is at the second position.

3. The portable communication device of claim 2, wherein a first surface of the sliding/pivoting housing is exposed when the sliding pivoting housing overlaps with the main body housing and the hinge axis is positioned at the first position, and
wherein a second surface of the sliding/pivoting housing is exposed when the sliding pivoting housing overlaps with the main body housing and the hinge axis is positioned at the second position.

4. The portable communication device of claim 3, wherein the sliding/pivoting housing moves to protrude from the first side of the main body housing from the overlapping position with the main body housing while rotating about the hinge axis when the hinge axis is positioned at the second position, and
wherein the sliding/pivoting housing overlaps with the main body housing when the hinge axis is moved from the second position to the first position.

5. The portable communication device of claim 2, further comprising:
hinge projections extending from each of an upper side and a lower side of the sliding/pivoting housing and mounted on the hinge axis; and
guide grooves provided in an inner wall of the mounting groove along a longitudinal direction thereof,
wherein the hinge projections are inserted into and move along the guide grooves to guide the sliding movement of the sliding/pivoting housing, the hinge projections providing the center of rotation of the sliding/pivoting housing.

6. The portable communication device of claim 5, further comprising:
fixing projections protruding from each of the upper side and the lower side of the sliding/pivoting housing, opposite to the hinge projections; and
fixing grooves provided in opposite ends of the inner walls of the mounting groove adjacent to the guide grooves,
wherein the fixing projections are selectively engaged with the fixing grooves as the sliding/pivoting housing slides.

7. The portable communication device of claim 6, wherein each fixing projection engages with a respective fixing groove to restrict the rotation of the sliding/pivoting housing when the sliding/pivoting housing overlaps with the main body housing.

8. The portable communication device of claim 2, wherein the sliding/pivoting housing pivots within a range of 180° about the hinge axis.

9. The portable communication device of claim 1, wherein the sliding/pivoting housing comprises:
a first key pad portion having a 3×4 key arrangement on a first surface thereof, and
a second key pad portion having a QWERTY key arrangement on a second surface thereof.

10. The portable communication device of claim 9, wherein the main body housing further comprises a display mounted adjacent to the mounting groove on the first surface thereof, and
wherein one of first key pad portion and the second key pad portion is flush with the display when the sliding/pivoting housing overlaps with the main body housing.

11. The portable communication device of claim 2, wherein the sliding/pivoting housing slides and rotates about the hinge axis from a position in which it overlaps with the main body housing.

12. A portable communication device, comprising:
a main body housing having a mounting groove on a first surface thereof and a hinge axis in a first side thereof, and
a sliding/pivoting housing to rotate about the hinge axis, such that the sliding/pivoting housing rotates about the hinge axis when a first side of the sliding/pivoting housing is positioned on the hinge axis.

13. The portable communication device of claim 12, wherein the first side of the sliding/pivoting housing is positioned at a first position while a first surface thereof is exposed when the sliding/pivoting housing overlaps with the main body housing,
wherein the first side of the sliding/pivoting housing is positioned at a second position when the sliding/pivoting housing slides to protrude from the first side of the main body housing, and
wherein the sliding/pivoting housing rotates about the hinge axis so as to overlap with the main body housing while a second surface thereof is exposed when the first side of the sliding/pivoting housing is positioned at the second position.

14. The portable communication device of claim 13, further comprising:
a hinge member mounted on the hinge axis with a portion thereof protruding from an inner wall of the mounting groove; and
guide grooves provided in each of a lower side and an upper side of the sliding/pivoting housing in a longitudinal direction thereof,
wherein the hinge member is inserted into the guide grooves to guide the movement of the sliding/pivoting housing, and provides a center of rotation of the sliding/pivoting housing when the first side of the sliding/pivoting housing is positioned at the second position.

15. The portable communication device of claim 14, wherein the hinge member comprises:
a first hinge projection having an outer flat circumferential face and positioned in the guide groove;
a second hinge projection extending from the first hinge projection and received in the main body housing, the second hinge projection having an outer circumferential face with a flat face and a curved face;
a hinge support piece received in the main body housing to contact the outer circumferential face of the second hinge projection; and
a hinge spring providing an elastic force forcing the hinge support piece against the outer circumferential face of the second hinge projection while being supported between the main body housing and the hinge support piece.

16. The portable communication device of claim 15, wherein the sliding/pivoting housing is stably restricted by the elastic force of the hinge spring when the hinge support piece is brought into close contact with the flat face of the second hinge projection.

17. The portable communication device of claim 15, wherein the sliding/pivoting housing slides when the hinge support piece is brought into close contact with the flat face of the second hinge projection.

18. The portable communication device of claim 15, wherein the sliding/pivoting housing overlaps with the main body housing with the one surface thereof exposed to the outside when the one side of the sliding/pivoting housing is positioned at the first position and the hinge support piece is brought into close contact with the flat face of the second hinge projection.

19. The portable communication device of claim 15, wherein the sliding/pivoting housing overlaps with the main body housing or protrudes from the first side of the main body housing with a second surface thereof exposed when the first side of the sliding/pivoting housing is positioned at the second position, and the hinge support piece is brought into close contact with the flat face of the second hinge projection.

20. The portable communication device of claim 14, wherein the sliding/pivoting housing comprises:
a first key pad portion having a 3×4 key arrangement on a first surface thereof, and
a second key pad portion having a qwerty key arrangement on a second surface thereof.

21. The portable communication device of claim 15, wherein the sliding/pivoting housing rotates, and the first hinge projection and the second hinge projection rotate about the hinge axis simultaneously when the outer flat face of the first hinge projection interferes with an inner wall of the guide groove of the sliding/pivoting housing.

22. The portable communication device of claim 15, wherein the hinge support piece is brought into contact with the curved face of the second hinge projection, and the hinge spring accumulates the elastic force to bring the hinge support piece into close contact with the flat face of the second hinge projection while a distance between opposite ends thereof is shortened when the sliding/pivoting housing slides.
